(19) United States
(12) Patent Application Publication
(10) Pub. No.: US 2018/0041882 A1
(43) Pub. Date: Feb. 8, 2018

(54) COMPUTERIZED METHODS FOR LOCATION-BASED SOCIAL NETWORKING

(71) Applicant: Joshua S. Schoonover, Carlsbad, CA (US)

(72) Inventor: Joshua S. Schoonover, Carlsbad, CA (US)

(21) Appl. No.: 15/650,748

(22) Filed: Jul. 14, 2017

Related U.S. Application Data
(60) Provisional application No. 62/362,494, filed on Jul. 14, 2016.

(51) Int. Cl. H04W 4/18; H04L 29/08; G06F 17/30; H04W 4/02

(52) U.S. Cl. CPC H04W 4/185; H04W 4/023; H04L 67/18; G06F 17/30041

(57) ABSTRACT

The disclosure concerns a method for location-based social networking, wherein, by way of a software program, a first actor within a social network is electronically invited by a second actor within the social network to unlock and access a media file being stored on an internet server; the media file being associated with a geographical position defined by the second actor. The media file is locked and inaccessible to the first actor unless the first actor is located within a pre-defined proximity of the geographical position associated with the media file. If the first actor carries a wireless device having a positioning system to a location near the geographical position associated with the media file, then the media file is unlocked and becomes accessible to the first actor.

### CROSS-REFERENCE TO RELATED APPLICATIONS

This application claims benefit of priority with U.S. Provisional Ser. No. 62/362,494, filed Jul. 14, 2016; the contents of which are hereby incorporated by reference.

### BACKGROUND OF THE INVENTION

### Field of the Invention

This invention relates to computerized methods for social networking; and more particularly, to computerized methods for sharing media files amongst actors within a social network conditioned on position-based access to the media files.

### Description of the Related Art

A social network is a social structure made up of a set of actors (such as individuals or organizations) and a complex set of the dyadic ties between these actors. In recent years, computerized social networks have become increasingly popular worldwide. Examples of computerized social network platforms include but are not limited to internet websites, such as: www.myspace.com; www.facebookcom; www.twitter.com; as well as mobile device applications such as, inter alia, INSTAGRAM, SNAPCHAT, and the like. The actors, or users of these computerized social network platforms, form an online social structure with powerful networking and virtual interaction capabilities.

With the advent of computerized social networks comes a need for novel applications designed to enhance virtual interaction between actors within these computerized social networks.

### SUMMARY OF THE INVENTION

A computerized method for sharing media files amongst actors within a social network utilizes position of a wireless device, and thus an inferred position of an actor holding such wireless device, to enable or disable access to the media files.

The computerized method for sharing media files amongst actors within a social network, comprises: determining a position of a wireless device; and if the position of the wireless device is within a pre-defined proximity to a geographical position associated with a media file, then unlocking the media file for access; otherwise locking the media file for preventing access.

In an embodiment, a software program is configured for: uploading a media file to a network server; associating the media file with a geographical position; and inviting one or more actors within a social network to unlock and access the media file by causing a wireless device of the invited actor(s) to become positioned in proximity with the geographical position associated with the media file, thereby unlocking the media file for access, such access including one or more of: download, playback, or similar use.

In another embodiment, a software program adapted for use with a wireless device is configured for: receiving a notification of a media file being made available for location-based access; communicating to one or more actors a geographical position associated with the media file; determining a position of the wireless device of the one or more actors; and communicating the position of the wireless device with a network server configured to unlock the media file for access if the position of the wireless device is in proximity to the geographical position associated with the media file, otherwise maintaining the media file in a locked and inaccessible state if the wireless device is outside the pre-defined proximity.

### BRIEF DESCRIPTION OF THE DRAWINGS

FIG. 1 illustrates a method for position-based social networking in accordance with an embodiment.

FIG. 2 illustrates a method for position-based social networking in accordance with another embodiment.

FIG. 3 illustrates a method for position-based social networking in accordance with yet another embodiment.

### DETAILED DESCRIPTION OF THE PREFERRED EMBODIMENTS

By way of a software program, a first actor within a social network is electronically invited by a second actor within the social network to unlock and access a media file being stored on an internet server; the media file being associated with a geographical position as defined by the second actor. The media file is locked and inaccessible to the first actor unless the first actor is located within proximity to the geographical position associated with the media file. If the first actor carries a wireless device having a positioning system to a location near the geographical position associated with the media file, then the media file is unlocked and becomes accessible to the first actor.

### Media File Upload and Geographical Association

A media file is produced using a typical camera, camcorder, text editor, or other application. The resulting media file may include: a photo, video, text message, any combination thereof or other similar media file.

An actor uploads the media file to a network server for storage and associates a geographical position with the media file. The geographical position can be associated with the media file by an action caused by an actor, such as but not limited to: selecting a position on a map; entering position coordinates, such as GPS coordinates and the like; or otherwise associating a geographical position with the media file in accordance with other known methods.

Alternatively, the geographical position can be automatically determined based on information obtained from metadata created by a device and associated with media, such as metadata created by a camera phone or the like. For example, the media file may be associated with a geographical position using metadata embedded or coupled to the media file; the metadata containing geographical position data, such as GPS coordinates.

The media file does not need to be associated with the location where it was created, though it may be. Instead, the media file can be created at a first geographical position and associated with a second geographical position that is distinct from the first geographical position for access by an invited actor at the second geographical location. For example, a video of a wife and mother can be created in the USA, and associated for unlocking at a military base in Japan where the husband and father can access it upon his arrival or proximity to the military base.

In this regard, a media file is created or selected and uploaded to a network server for storage and distribution, wherein the media file is associated with a geographical position.

### Notification of Media File Availability

The actor who uploads the media file to the server may invite one or more other actors within a social network to access the media file. The invitation can be sent via a computerized social media platform, such as FACEBOOK or INSTAGRAM, or via text message, email, or other similar method. In general, the invitation can contain a message that a media file is available for access and a geographical position where the media file can be accessed via download, streaming playback, or other delivery.

If desired, the actor who uploads the media file to the server can make the media file available to any actor who becomes in proximity to the geographical position associated with the media file. For example, a video file describing a history of the Golden Gate Bridge in San Francisco, Calif. can be accessed by anyone who becomes in proximity to the bridge (but not by actors who are considered to not be in such proximity). In this regard, the media file can be made publicly available without restriction to any user having a wireless device and software configured to notify the user when the media file is unlocked and available based on the user's location.

Otherwise, the actor who uploads the media file to the server can make the media file available to only select actors by invitation, and only where an invited actor becomes in proximity to the geographical position associated with the media file. For example, a parent can record a media file comprising a video of her child's first ride on a bicycle, upload the video to a network server and associate the geographical location of the first bicycle ride with the video, and invite the child to access the video by visiting the geographical location at a later time. The media file is stored on the network server and metadata associates the video with a phone number, email, account, or other identifier associated with the child. In this regard, the media file becomes accessible only to the invited child, requiring (i) verification of the identifier of the child (phone number, account login, etc.), and (ii) proximity to the geographical location associated with the media file. In this regard, the child may grow up over several years and one day choose to visit a geographical location where her first bicycle ride occurred, and at that location the child may be able to access, using the software, and view the video media file planted by the parent so many years ago.

Many media files may be created and uploaded by an actor, for the benefit of another actor, and shared between accounts of the actors for subsequent access.

Generally, a wireless device can be configured to produce an audible or physical notification when a media file has become available by way of direct invite or by unlocking a public media file based on position.

The notification can be created and sent at the time an actor creates and shares a media file. Alternatively, an invitation can be sent and remain available to the invited actor for acceptance at any later date by storing the invitation as being associated with the invited actor, or an account associated with the invited actor.

### Accessing a Position-Based Media File

A first actor in a social network is invited by a second actor in the social network to view a media file associated with a geographical position. The first actor receives a notification concerning the general availability and containing the geographical position of the media file required for unlocking and access. The first actor may also become notified of the source or actor who makes the media file available for access, a time period or window for which the media file is available, or other information. The first actor then carries a wireless device, such as a cell phone, tablet, laptop, or other device, to a location in proximity to the geographical position associated with the media file. Once the first actor is in proximity of the geographical position, for example within 100 meters or other distance configured by the second actor or set as default by the system implementing the software, the wireless device, sending position information to the network server, unlocks the media file and the first actor is prompted to download, playback, or otherwise access the media file while being located in proximity to the geographical position of the media file.

Although it may not be required to upload a media file at the geographical position to be associated therewith, it is such a requirement that any user accessing the media file be located in proximity to the geographical position in order to unlock and access the media file.

### Various Applications for Position-Based Social Networking

In one example, a user uploads to a network server a plurality of media files, including videos, photos, and/or text messages, which are each associated with respective geographical positions as defined by the user; for example by entering GPS coordinates or selecting a location on a map, either for each individual media file or for a grouping of media files. The media files may include a video of a baby's first steps, a picture of a child in front of her school on the first day of class, an audio or text message from a father to his child, or other media files. The media files can be made available to the user's family members by one of: the user selecting family member profiles from a computerized social media platform (ex: FACEBOOK, INSTAGRAM or the like) for inviting the selected family members to view the respective media files; or entering a phone number, email address, or username associated with each family member being invited. The family members are thereafter notified of the available media files and associated geographical positions; for example via email, text, or private message, or the invitation is stored in the software for later invitation upon creation of a particular user account (ex: a baby' s name and birthday can be tied to a media file, and when old enough the baby creates an account to discover his or her invitations to access the media files). The family members can then visit locations proximate to the media files and unlock the files for viewing, download, or other use. In this regard, the media files are used to motivate the family members to travel to, and access, the various media files.

In another example, a video presentation is associated with the location of a national monument and stored on a network server. The video presentation is defined on the server as being available to the any device when in proximity to the national monument. A tourist visits the national monument and is notified on her wireless device, via a software platform or otherwise, that a video presentation is unlocked and available for playback while near the monument. The user selects an option to view the video presentation and her device opens a video playback application and begins to play the video. In this regard, various media files can be made publicly available when a device is in proximity to a geographical position associated with the respective media files.

In another example, a game is provided, such as a scavenger hunt or trivia challenge, whereby a number of game players are each awarded points for locating various media files and performing acts or answering pre-programmed questions correctly.

In another example, a user can upload various media files associated with respective geographical positions to a network server. Over his lifetime, the user accumulates a plurality of media files stored on the network server. After several years, the user can give access to the various media files to his survivors, and his survivors can retrace the user's steps to experience each or a portion of the media files as they are unlocked by becoming in proximity with respective geographical positions. Thus, a child can trace his father's major life events and relive them through a virtual access to the stored media files.

In yet another example, a user might have a meal at a local restaurant and after enjoying the meal the user may decide to upload a text message and/or photo to the network server, indicating the meal that was enjoyed at the restaurant, and sending a notification to the user's friends suggesting that details to a pleasant meal are available for access when the friends become located in proximity to the restaurant. Upon visiting the restaurant, the friends can learn of the recommended dish and the experience had by the initial actor.

In another embodiment, once the user unlocks a media file, the media file may be configured to remain unlocked and accessible within the user's account for later playback from any location using an internet connection. Thus, once unlocked, the media file becomes remotely accessible.

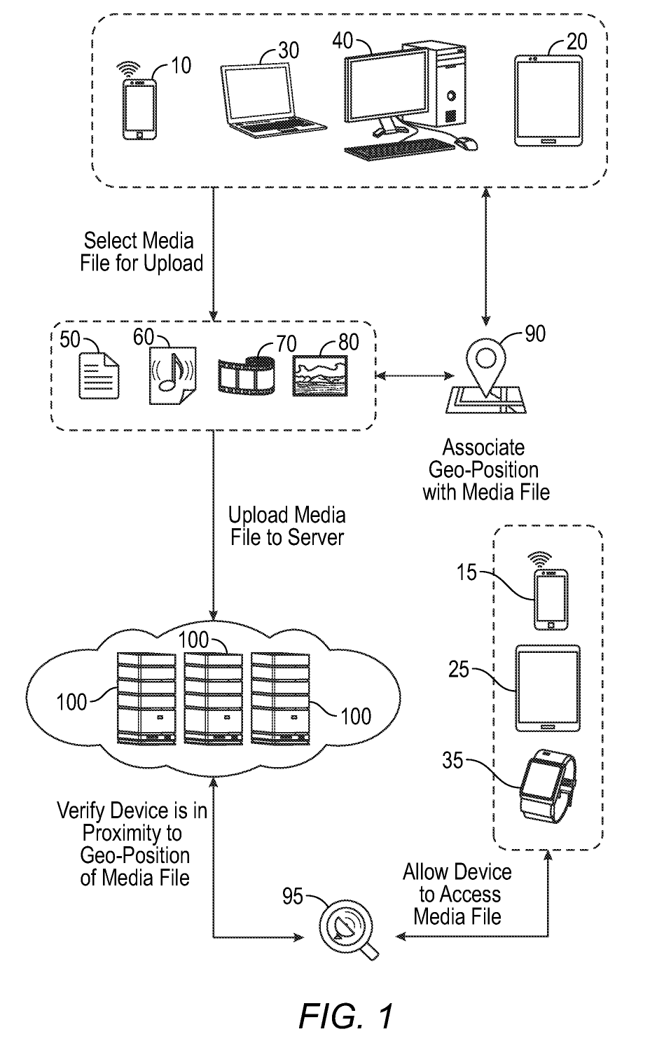

Now turning to the drawings, FIG. 1 shows a general schematic illustrating a computerized method for location-based social networking. The method begins with using a first device, such as a mobile phone 10 (also referred to as a “cell phone”), a tablet 20, a laptop 30, or a personal computer (“PC”) 40, to select at least one media file for uploading to a server. For purposes of illustrating the method, this example will assume a single media file; however, it is possible to concurrently upload multiple media files to the server. The media file comprises one of: a text message 50; an audio file 60; a video file 70; or an image 80. A geographical position 90 is associated with the media file, either manually as selected by a first user or automatically as default geo-position extracted from metadata associated with the media file (i.e. where the file was created). The media file is uploaded to a server 100. A second device, taking the form of a portable wireless communication device, includes: a mobile phone 15, tablet 25, smart watch 35, or other portable device, attempts to access the media file from the server 100. Software 95, configured either on the client-device side, or on the server side, compares position information associated with the second device, thereby determining if the second device is within a pre-defined proximity of the geographical position 90 and if so, the media file becomes unlocked and accessible by the second device, but if not the media file remains locked and inaccessible.

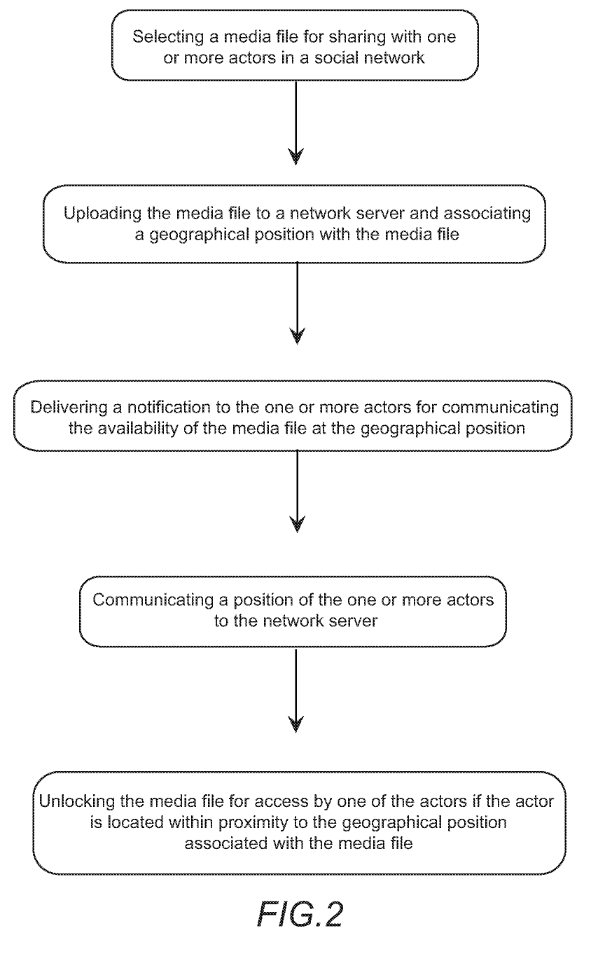

FIG. 2 illustrates a method for position-based social networking, comprising: selecting a media file for sharing with one or more actors in a social network; uploading the media file to a network server and associating a geographical position with the media file; delivering a notification to the one or more actors for communicating the availability of the media file at the geographical position; communicating a position of the one or more actors to the network server; and unlocking the media file for access by one of the actors if the actor is located within proximity to the geographical position associated with the media file.

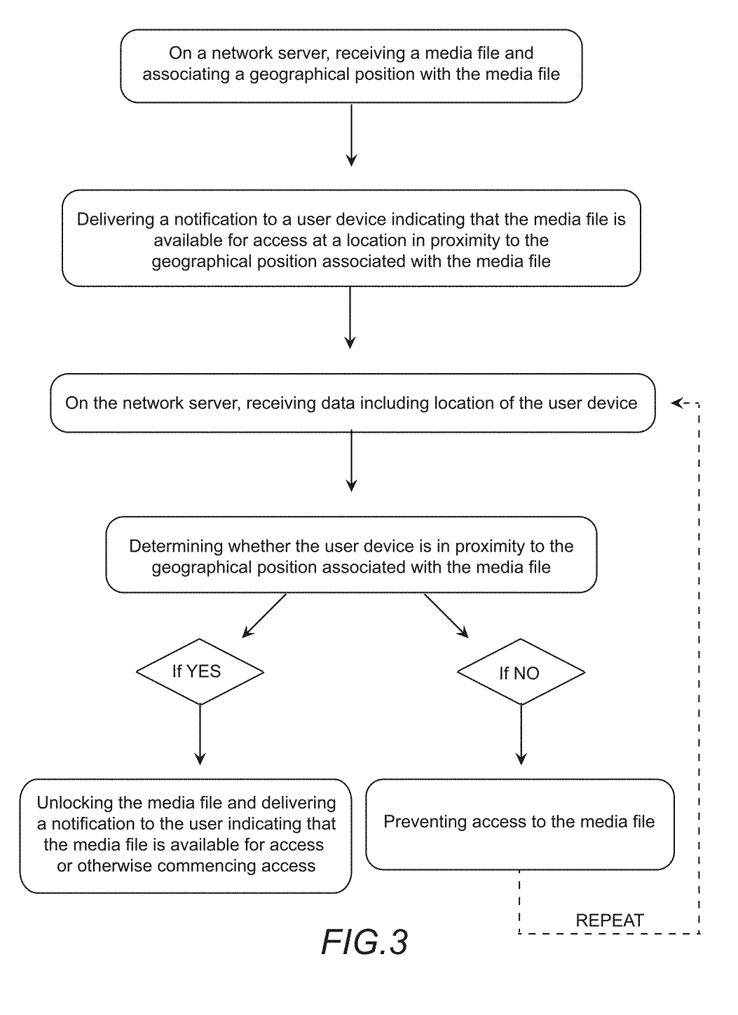

FIG. 3 illustrates a method for position-based social networking, comprising: on a network server, receiving a media file and associating a geographical position with the media file; delivering a notification to a user device indicating that the media file is available for access at a location in proximity to the geographical position associated with the media file; on the network server, receiving data including location of the user device; determining whether the user device is in proximity to the geographical position associated with the media file; whereas the media file is unlocked and a notification is delivered to the user indicating that the media file is available for access if the user device is located in proximity to the geographical position associated with the media file; and whereas the media file remains locked if the user device is not in proximity to the geographical position associated with the media file. The server continues to repeat the steps of receiving the location of the user device, and determining proximity with the geographical position of the media file until either the application is closed or the device is placed in proximity to the geographical position, thereby unlocking the media file for user access.

While certain features and embodiments are described herein with the intent to enable one with skill in the art to practice the invention, it should be recognized that a certain variations, combinations, substitutions, and other alternatives may be similarly practiced without departing from the spirit and scope of the invention. As such, the one with skill in the art will be capable of varying the herein-described embodiments to accomplish other embodiments which are substantially similar and which are deemed to be within the scope of the invention as-claimed.

What is claimed is:

1. A computerized method for sharing a media file amongst actors within a social network, the media file being stored on a network server, the method comprising:
determining a location of a wireless device; and
if the location of the wireless device is within a pre-defined proximity to a geographical position associated with the media file, then unlocking the media file for access by the wireless device;
otherwise preventing access to the media file.

2. The method of claim 1, wherein after the media file is unlocked, the media file remains accessible to the user indefinitely.

3. The method of claim 1, wherein the media file comprises one or more of: a video, image, text message, audio file, or a combination thereof.

4. The method of claim 1, wherein said pre-defined proximity includes a 100 meter radius of the geographical position associated with the media file.

5. The method of claim 1, wherein said determining a location of a wireless device comprises obtaining global positioning system (GPS) coordinates of the device.

6. The method of claim 1, wherein said determining a location of a wireless device comprises triangulating the location of the device based on antenna signal measured by at least three cellular network towers.

7. A system configured for position-based social networking, comprising:
a network server configured to store at least one media file having a geographical position associated therewith;
a wireless device configured to communicate a location thereof to the network server;
the network server being further configured to deliver a media file to the wireless device only if the wireless device is located within a pre-determined proximity to the geographical position associated with the media file.

8. The system of claim 7, wherein at least one of the wireless device and the network server comprises software configured to execute the steps of:
determining the location of the wireless device; and
if the location of the wireless device is within the pre-defined proximity to the geographical position associated with the media file, then unlocking the media file for access by the wireless device;
otherwise preventing access to the media file.
